(19) United States
(12) Patent Application Publication
(10) Pub. No.: US 2011/0148784 A1
(43) Pub. Date: Jun. 23, 2011

(54) DISPLAY APPARATUS AND TOUCH DISPLAY APPARATUS

(76) Inventor: Tsung-Ting LEE, Chiayi County (TW)

(21) Appl. No.: 12/786,888

(22) Filed: May 25, 2010

(30) Foreign Application Priority Data
Dec. 21, 2009 (TW) 098143943

(51) Int. Cl. G06F 3/041; G06F 3/038

(52) U.S. Cl. 345/173; 345/205

(57) ABSTRACT

A display apparatus includes a display module and a covering material. The display module includes a display surface. The covering material has a transparent portion for covering the display surface. The covering material further covers a lateral side of the display module so that the side of the covering material at the display surface is substantially seamless. A touch display apparatus is also disclosed.

### CROSS REFERENCE TO RELATED APPLICATIONS

This Non-provisional application claims priority under 35 U.S.C. §119(a) on Patent Application No(s). 098143943 filed in Taiwan, Republic of China on Dec. 21, 2009, the entire contents of which are hereby incorporated by reference.

### BACKGROUND OF THE INVENTION

1. Field of Invention

The present invention relates to a display apparatus and a touch display apparatus.

2. Related Art

As the progress of flat panel display technique, conventional cathode ray tubes display apparatuses were gradually replaced by liquid crystal display apparatuses with thin sizes, low power consumption and no radiation. Moreover, the liquid crystal display apparatuses have been applied in various electronic products.

Generally, a liquid crystal display apparatus includes a liquid crystal display panel and a backlight module. The liquid crystal display panel substantially includes two substrates and a liquid crystal layer disposed between two substrates. The homogeneous light emitted from the backlight module penetrates through the liquid crystal display panel and is then modulated for generating colorful images.

FIG. 1A is a cross-sectional figure of a conventional liquid crystal display apparatus 1a. The liquid crystal display apparatus 1a includes a liquid crystal display panel 11, a backlight module 12, a mold frame 13 and a frame 14. The liquid crystal display panel 11 and the backlight module 12 are disposed opposite to each other. The mold frame 13 is disposed between the liquid crystal display panel 11 and the backlight module 12 and is partially protruded so as to support the liquid crystal display panel 11 and define a distance between the liquid crystal display panel 11 and the backlight module 12. The liquid crystal display panel 11, the backlight module 12 and the mold frame 13 are disposed in the frame 14.

The liquid crystal display panel 11 includes a thin film transistor substrate 111 and a color filter substrate 112 disposed opposite to each other, and a liquid crystal layer is disposed between the thin film transistor substrate 111 and the color filter substrate 112. The backlight module 12 comprises a light-emitting unit 121, a light guide plate 122, a reflective element 123 and a set of optical films 124. The aforementioned components or elements are conventional in this field, and the detailed description thereof will be omitted.

In accordance with the configuration of the liquid crystal display apparatus 1a, it further includes a front case 16a and a rear case 16b used as the external appearance of the liquid crystal display apparatus 1a. However, seams are formed between the front case 16a and the frame 14 in certain configuration, and disposition of dust and foreign material frequently occur. It consequentially affects the performance of the liquid crystal display apparatus 1a. Moreover, the gap formed between the front case 16a and the liquid crystal display panel 11 results in the impediment of full planarization and appearance.

FIG. 1B is a schematic figure illustrating the configuration of a conventional liquid crystal display apparatus without gap. A cover glass 15 is used to cover the whole liquid crystal display apparatus 1b, and match with the front case 16a and the rear case 16b. However, a slight seam is still formed between the rear case 16b and the cover glass 15 (close to the lateral side of the liquid crystal display apparatus 1b).

Therefore, it is an important subject of the invention to provide a full planarized display apparatus and touch display apparatus able to prevent the entrance of foreign material.

### SUMMARY OF THE INVENTION

In view of the foregoing, the present invention provides a full planarized display apparatus and touch display apparatus able to prevent the entrance of foreign material so as to promote product competitiveness and display performance.

To achieve the above, a display apparatus in accordance with the present invention includes a display module and a covering material. The display module has a display surface. A transparent portion of the covering material covers the display surface. The covering material further covers a lateral side of the display module, so that the side of the covering material at the display surface is substantially seamless.

To achieve the above, a touch display apparatus in accordance with the present invention includes a touch panel, a display module and a covering material. The touch panel includes a touch surface. The display module is disposed opposite to the touch panel. The covering material has a transparent portion for covering the touch surface of the touch panel. The covering material further covers a lateral side of the display module, so that the side of the covering material at the touch surface is substantially seamless.

In summary, the transparent portion of the covering material in accordance with the present invention covers the display module or the display surface of the touch panel and the covering material is substantially seamless. Therefore, it prevents foreign material from entering the inside of the display apparatus and thereby promotes the display performance. Furthermore, the covering material used as a case to protect the display module or touch panel enables the apparatus to become a solid and durable human-machine interface apparatus, which can be operated independently or in combination and cooperate with various systems. Moreover, it also can achieve the aim of planarization for increasing product competitiveness.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A and 1B is cross-sectional figures of a conventional liquid crystal display apparatus;

FIG. 2A to 2C are schematic figures of different aspects in accordance with the first embodiment of the present invention;

FIG. 3A to 3E are schematic figures of different aspects in accordance with the second embodiment of the present invention; and

FIGS. 4A and 4B are schematic figures of different aspects in accordance with the third embodiment of the present invention.

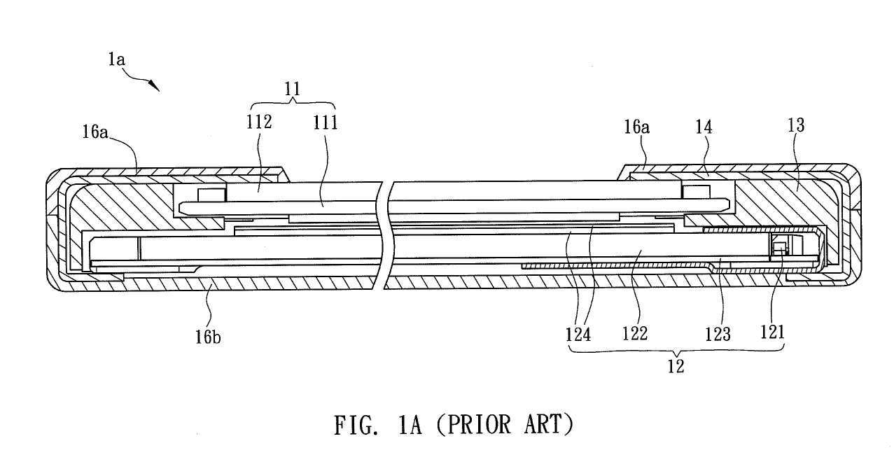

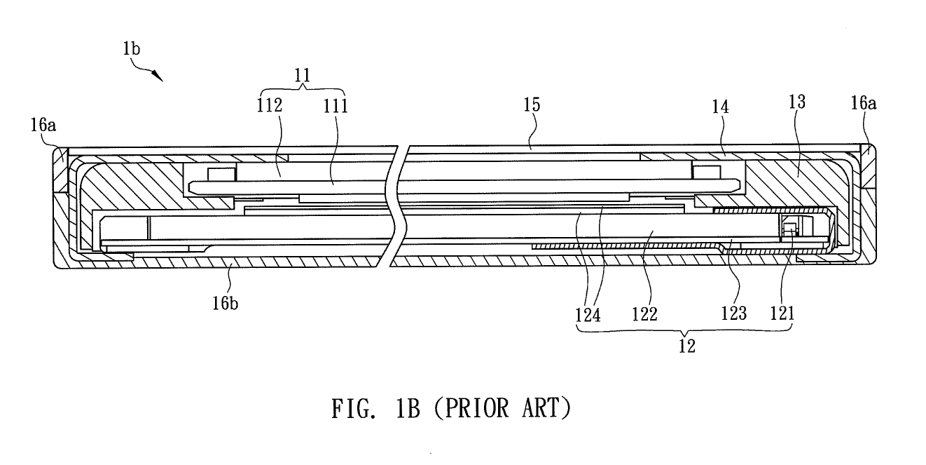

### DETAILED DESCRIPTION OF THE INVENTION

The present invention will be apparent from the following detailed description, which proceeds with reference to the accompanying drawings, wherein the same references relate to the same elements.

### First Embodiment

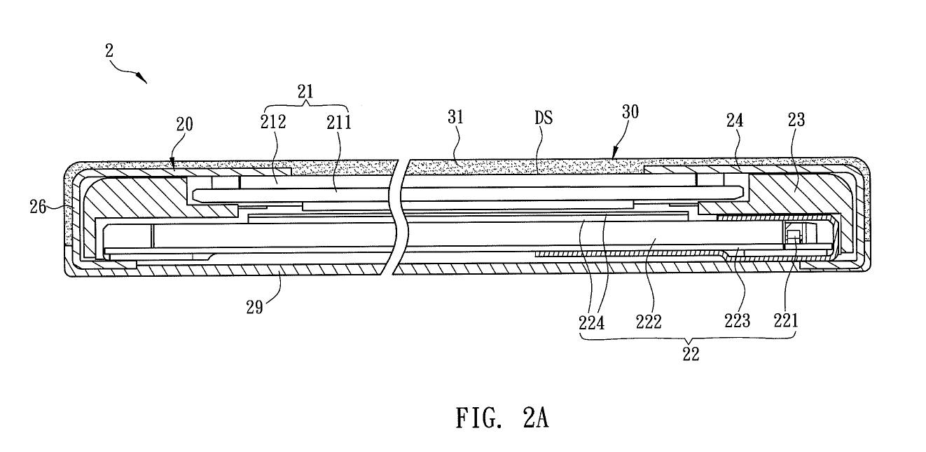

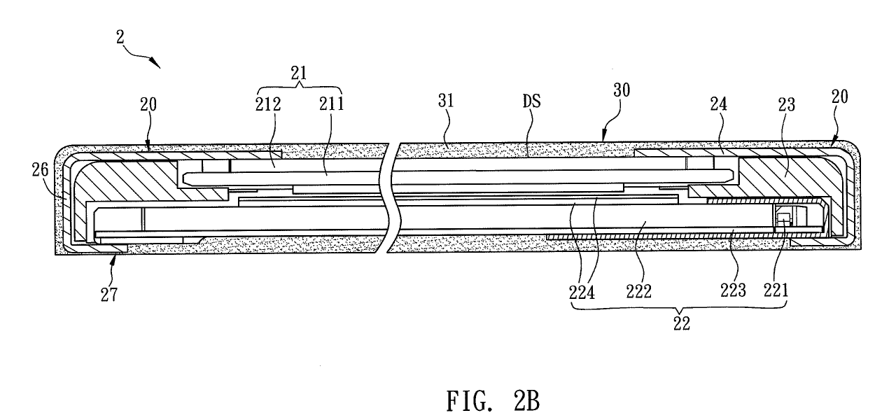

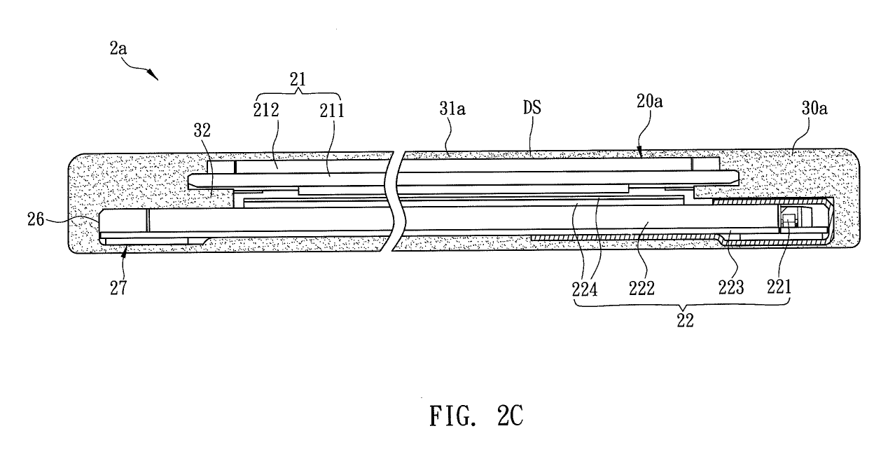

As shown in FIG. 2A, a display apparatus 2 in accordance with a preferably embodiment of the present invention includes a display module 20 and a covering material 30. The display module 20 can be for example a liquid crystal display module, an organic light-emitting diode display module, a plasma display module, an electronic paper display module or other display modules. In this embodiment, the display module 20 is for example a liquid crystal display module.

The display module 20 includes a display panel 21 and a backlight unit 22. The backlight unit 22 is disposed opposite to the display panel 21, and the mold frame 23 is disposed between the display panel 21 and the backlight unit 22 to support the display panel 21 and define a distance between the display panel 21 and the backlight unit 22. A portion of the mold frame 23 is protruded from the display panel 21 and the backlight unit 22. The display module 21, the backlight panel 21 and the mold frame 23 are disposed in a frame 24.

The display panel 21 can include a thin film transistor substrate 211 and a color filter substrate 212, and a liquid crystal layer is disposed therebetween. The backlight module 22 includes a light-emitting unit 221, a light guide plate 222, a reflective element 223 and a set of optical films 224. The aforementioned components or elements are conventional in the present field such that the detailed description thereof will be omitted. The structure of the liquid crystal display module shown in FIG. 2A is only for exemplary description, and not used to limit the scope of the present invention. Otherwise, the display module 20 includes a display surface DS representing the last physical surface through which the light emitted from the display panel 21 penetrates before entering human eyes. To be noted, the effective display area of the certain physical surface is defined within the frame 24, and the physical surface is for example the outer surface of the polarization plate.

The covering material 30 includes a transparent portion 31 covering the display surface DS and extending to the frame 24. The side of the covering material close to the display surface DS is thicker than the altitude difference between the frame 24 and the display surface DS. The covering material described herein is for example completely consisted of the transparent portion 31, and the area of the transparent portion 31 is larger than the display surface DS. In other words, the transparent portion 31 completely covers the display surface DS, and the light emitted from the display panel 21 still can penetrate through the transparent portion 31. The outer surface of the transparent portion 31 can be a planar surface or an arc surface. The outer surface of the transparent portion 31 described herein is for example a planar surface.

Otherwise, the covering material 30 further covers a lateral side 26 of the display module 20 so that the side of the covering material at the display surface is substantially seamless. In other words, the side of the covering material 30 close to the display surface DS can be a continuous or have no gap and be integrally formed as one piece. The transparent portion described herein is for example a continuous surface without gap. Therefore, the display surface DS can be covered by the covering material 30 and the transparent portion 31 thereof completely such that it prevents foreign material (such as dust and liquid) from entering the inside of the display module 20, which may affect the display performance of the display module 20. In addition, the display apparatus 2 may further include a rear case 29 connected with the backlight unit 22, the frame 24 and/or the covering material 30.

The display surface DS and the lateral side 26 can be covered by the covering material 30 in an insert injection molding process or an injection molding process. The material of the covering material 30 can be for example a transparent polymer material such as a thermoplastic polymer material. The material of the covering material 30 is for example polycarbonate, poly(methyl methacrylate) or composite plastic such that the covering material 30 can be flexible.

The covering material 30 covers the display surface DS and a back surface of the display module opposite to the display surface DS as well. As shown in FIG. 2B, the covering material 30 further covers the back surface of the display module opposite to the display surface DS, which is shown as the back side 27 of the display module 20. Additionally, in accordance with the aspect of the present embodiment shown in FIG. 2B, the display apparatus 2 needs no rear case 29 because the covering material 30 can replace the rear case 29 to provide fixing and protection functions. The aforementioned covering material 30 can be integrally formed as one piece by injection molding or assembled by two pieces respectively formed by injection molding.

FIG. 2C is a schematic figure of a display apparatus 2a in accordance with another aspect of the present embodiment. The technical characteristic of the present aspect is different from the aforementioned one in that the display apparatus 2a uses the covering material 30a instead of a conventional case or the frame and the mold frame in the aforementioned embodiment. The covering material 30a covers the display surface DS and the lateral side 26 of the display module 20, and a portion 32 of the covering material 30a further extends and is disposed between the display panel 21 and the backlight unit 22 to replace the mold frame in defining a distance between the display panel 21 and the backlight unit 22. In accordance with the present embodiment, the display panel 21 and the backlight unit 22 can be assembled first, and then covered by the covering material 30a in an injection molding process. Alternatively, one of the display module 21 and the backlight unit 22 is set in a mold, and then covered by the covering material 30a in an injection molding process. Continuously, the processed module or unit is set in another mold with the other one of the display module 21 and the backlight unit 2 to form the display apparatus 2a in a second injection molding process.

### Second Embodiment

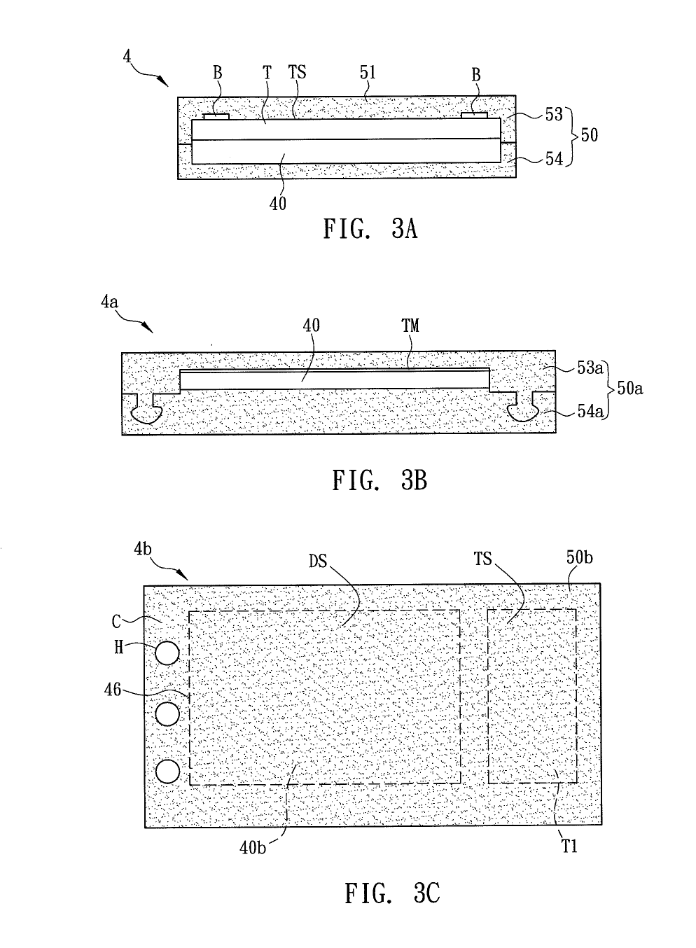

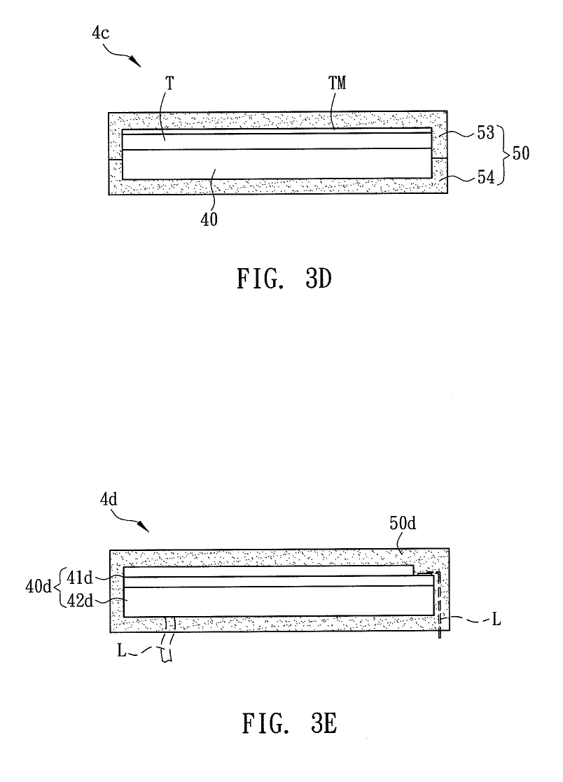

The connection configuration between the display module and the covering material is various. The following and accompanying schematic figures FIG. 3A to 3E indicate an example for description.

As shown in FIG. 3A, a display apparatus 4 includes a touch panel T, a display module 40 and a covering material 50. Because the display apparatus 4 includes the touch panel T, it can be considered as a touch display apparatus. The touch panel T includes a touch surface TS. The touch panel T can be for example a pressure sensitive type, an electric resistance type, an electric capacitance type, an infrared type, an ultrasonic type or an optic imaging type touch panel, which is disposed in front of the display module 40. Alternatively, the touch panel T can be for example an electromagnetic type touch panel, which is disposed behind the display module 40.

The display module is disposed opposite to the touch panel T, and can be for example a liquid crystal display module, an organic light-emitting diode display module, a plasma display module, an electronic paper display module or other display modules.

The covering material 50 includes a transparent portion 51. The transparent portion 51 covers the touch surface TS of the touch panel T and is substantially seamless. The major technical characteristics of the covering material 50 have been described above such that the detailed description thereof will be omitted. Otherwise, the covering material 50 further covers the touch panel T, the lateral side of the display module 40 and the back side of the display module 40 opposite to the touch panel T.

The major difference between the covering material 50 of the present aspect and that of the aforementioned embodiment is the covering material 50 includes a plurality of sections 53 and 54. The section 53 includes a transparent portion 51. The sections 53 and 54 can be connected by locking, adhesion, mounting, injection molding or a combination thereof. Alternatively, the sections 53 and 54 respectively include a concave and/or a convex matching each other for connection. The sections 53 and 54 described herein are connected by for example adhesion and injection molding.

Moreover, the touch display apparatus 4 further includes a buffer element B disposed between the covering material 50 and the display module 40. The buffer element B described herein is disposed for example between the touch surface TS of the touch panel T and the covering material 50. In addition, the buffer element B has to be disposed in the non-display area of the display module 40. The buffer element B can be for example twin adhesive, foam, rubber, plastic or other elements with buffer function. Certainly, if the buffer element B is a light permeable element, it can be disposed in the display area of the display module 40.

FIG. 3B is a schematic figure of the display apparatus 4a in accordance with another aspect of the present embodiment. The covering material 50a of the present aspect includes two sections 53a and 54a. Each of the two sections 53a and 54a respectively includes a concave and/or a convex matching each other for connection. Moreover, the display apparatus 4a can further include a transparent medium TM disposed between the covering material 50a and the display module 40. The refractive index of the transparent medium TM can be between that of the covering material 50a and that of the display module 40. The transparent medium TM can be colloid or fluid. The disposition of the transparent medium TM can reduce light reflection to improve display quality.

FIG. 3C is a schematic top view of the display apparatus 4b in accordance with other aspect of the present embodiment. The touch display apparatus 4b includes a display module 40b and a touch panel T1. The touch panel T1 is disposed adjacent to the display module 40b and includes a touch surface TS. The covering material 50b covers the display surface DS and the touch surface TS. The covering material 50b further covers a lateral side 46 of the display module 40b, and the covering material 50b includes a connection portion C at the lateral side. The connection portion C described herein includes at least one hole H. The connection portion C can be used to connect with other elements.

As shown in FIG. 3C, the covering material in accordance with the embodiment of the present invention can cover the display module and the touch panel simultaneously. However, certain configuration is used for an exemplary description but not to limit the scope of the present invention. The covering material of the present invention also can cover more than two display modules for display only. Otherwise, one of the two display modules covered by the covering material includes the touch panel, and the configuration in accordance with the present aspect includes a touch display apparatus and a display module. Alternatively, both of the two display modules covered by the covering material can include touch panels, and the covering material is formed to simultaneously cover the two touch display apparatus, which are substantially located on the same plane.

FIG. 3D is a schematic figure of the display apparatus 4c in accordance with other aspect of the present embodiment. The display apparatus 4c further includes a transparent medium TM disposed between the covering material 50 and the touch panel T. The refractive index of the transparent medium TM is between that of the covering material 50 and that of the touch panel T. The transparent medium TM is colloid or fluid. The disposition of the transparent medium TM can reduce light reflection to improve display quality.

As shown in FIG. 3E, the display apparatus 4d in accordance with other aspect of the present embodiment includes a display module 40d and a covering material 50d. The display module 40d includes a display panel 41d and a backlight unit 42d. The display apparatus 4d further includes at least one electronic connection member L electrically connected to the display module 40d and protruding out of the covering material 50d. The electronic connection member L is a conducting wire, a connector or other types of electronic connection members. The electronic connection member L described herein is for example a conducting wire. The electronic connection member L is electrically connected to the display panel 41d and the backlight unit 42d, respectively, and protrudes out of the covering material 50d for connecting to external electronic elements such as a driving circuit board. Alternatively, if the electronic connection member L is a connector, it can be directly inserted by the external electronic elements.

### Third Embodiment

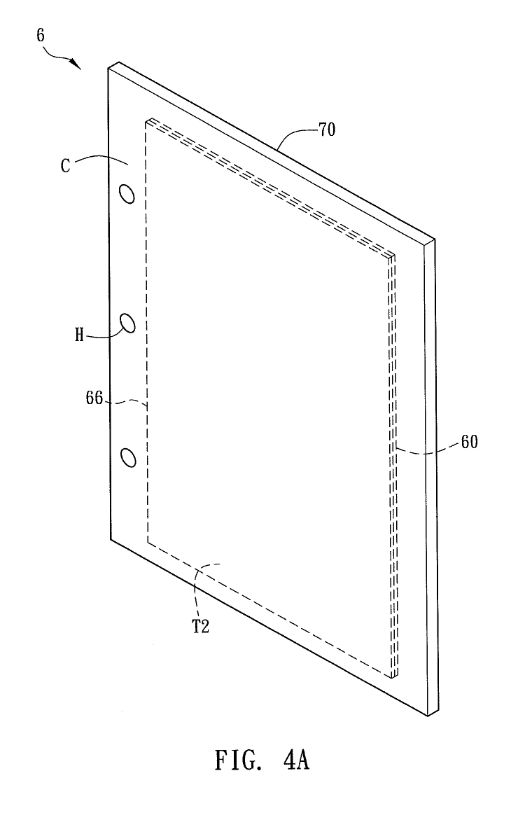

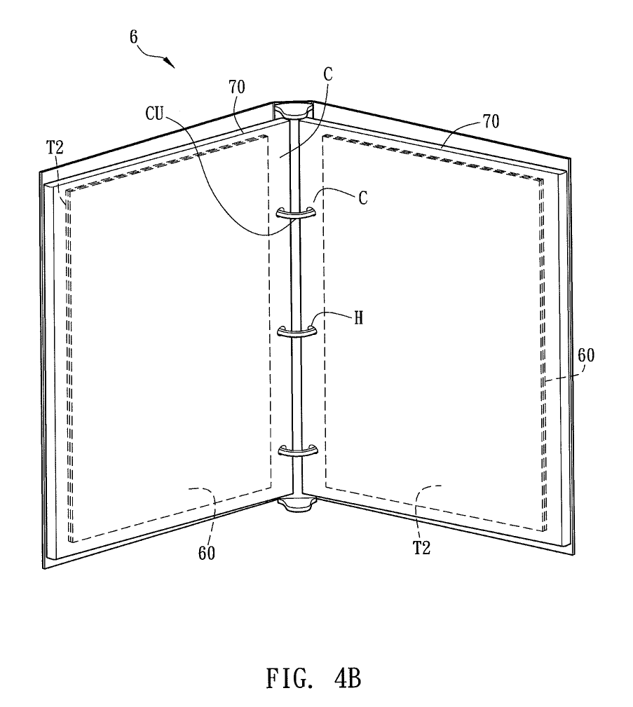

The display apparatus and the touch display apparatus of the present invention can be applied in various fields, and, in particular, the touch display apparatus can be considered as a display apparatus with a touch panel. The following and accompanying FIGS. 4A and 4B indicate an example for description.

As shown in FIG. 4A, a touch display apparatus 6 in accordance with an aspect of the present embodiment includes a display module 60, a touch display panel T2 and a covering material 70. The display module 60 is disposed opposite to the touch panel T2. The covering material 70 further covers a lateral side 66 of the touch panel T2 and the display module 60, and the covering material includes a connection portion C at the lateral side. The connection portion C can include various structures, for example a concave, a convex, a screw hole or a through hole. The connection portion C described herein includes for example a through hole H. The connection portion C can be used to connect with other elements or devices for expanding application fields.

As shown in FIG. 4B, the touch display apparatus 6 further includes a connection unit CU connected with the connection portion C. The connection unit CU can includes a pivot, an O ring, a spiral ring, a rope, a line segment, an adhesive agent or other element used for connection. The connection unit CU described herein is for example an O ring, and disposed in a protection cover. In addition, the connection unit CU is also connected to a connection portion C of another covering material 70 in order to connect a plurality of display modules for expanding application fields. However, the sorts of the display modules can be various.

To be noted, the technical characteristics of the aforementioned embodiments can be randomly combined, and thereby the detailed description thereof will be omitted.

In summary, the transparent portion of the covering material in accordance with the present invention covers the display module or the touch panel and the covering material is substantially seamless. Therefore, it prevents foreign material from entering the inside of the display apparatus and thereby promotes the display performance. Furthermore, the covering material used as a case to protect the display module or touch panel enables the apparatus to become a solid and durable human-machine interface apparatus, which can be operated independently or in combination and cooperate with various systems. Moreover, it also can achieve the aim of planarization for increasing product competitiveness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus, comprising:
a display module comprising a display surface; and
a covering material having a transparent portion for covering the display surface, wherein the covering material further covers a lateral side of the display module, so that the side of the covering material at the display surface is substantially seamless.

2. The display apparatus of claim 1, wherein the outer surface of the transparent portion is substantially a planar surface or an arc surface.

3. The display apparatus of claim 1, wherein the covering material is a transparent thermoplastic polymer material.

4. The display apparatus of claim 1, wherein the covering material further covers a back surface of the display module opposite to the display surface.

5. The display apparatus of claim 1, further comprising:
a buffer element disposed between the covering material and the display module.

6. The display apparatus of claim 4, further comprising:
an electronic connection member electrically connected to the display module and protruding out of the covering material.

7. The display apparatus of claim 4, wherein the covering material comprises a plurality of sections and one of the sections comprises the transparent portion.

8. The display apparatus of claim 1, further comprising:
a transparent medium disposed between the covering material and the display module.

9. The display apparatus of claim 1, wherein the display module comprises:
a display panel; and
a backlight unit disposed opposite to the display panel.

10. The display apparatus of claim 9, wherein a portion of the covering material extends and is disposed between the display module and the backlight unit to define a distance between the display panel and the backlight unit.

11. The display apparatus of claim 1, wherein the covering material comprises a connection portion at the lateral side.

12. The display apparatus of claim 11, further comprising:
a connection unit connected to the connection portion.

13. The display apparatus of claim 12, wherein the connection unit comprises a pivot, an O ring, a spiral ring, a rope, a line segment or an adhesive agent.

14. The display apparatus of claim 1, further comprising:
a touch panel disposed adjacent to the display module and comprising a touch surface, wherein the covering material further covers the touch surface.

15. A touch display apparatus, comprising:
a touch panel comprising a touch surface;
a display module disposed opposite to the touch panel; and
a covering material having a transparent portion for covering the touch surface of the touch panel, wherein the covering material further covers a lateral side of the display module, so that the side of the covering material at the touch surface is substantially seamless.

16. The touch display apparatus of claim 15, wherein the outer surface of the transparent portion is substantially a planar surface or an arc surface.

17. The touch display apparatus of claim 15, wherein the covering material is a transparent thermoplastic polymer material.

18. The touch display apparatus of claim 15, wherein the covering material further covers a back surface of the display module opposite to the display surface.

19. The touch display apparatus of claim 15, further comprising:
a buffer element disposed between the covering material and the display module.

20. The touch display apparatus of claim 18, further comprising:
an electronic connection member electrically connected to the display module or touch panel and protruding out of the covering material.

21. The touch display apparatus of claim 18, wherein the covering material comprises a plurality of sections and one of the sections comprises the transparent portion.

22. The touch display apparatus of claim 15, further comprising:
a transparent medium disposed between the covering material and the display module.

23. The touch display apparatus of claim 15, wherein the display module comprises:
a display panel; and
a backlight unit disposed opposite to the display panel.

24. The touch display apparatus of claim 23, wherein a portion of the covering material extends and is disposed between the display panel and the backlight unit to define a distance between the display panel and the backlight unit.

25. The touch display apparatus of claim 15, wherein the covering material comprises a connection portion at the lateral side.

26. The touch display apparatus of claim 25, further comprising:
a connection unit connected to the connection portion.

27. The touch display apparatus of claim 26, wherein the connection unit comprises a pivot, an O ring, a spiral ring, a rope, a line segment or an adhesive agent.
